(19) United States
(12) Patent Application Publication
(10) Pub. No.: US 2020/0149300 A1
(43) Pub. Date: May 14, 2020

(54) METHOD FOR PRODUCING A CONCRETE FORMWORK FOR A TOWER SEGMENT, AND METHOD FOR PRODUCING A TOWER SEGMENT FOR A TOWER OF A WIND TURBINE

(71) Applicant: Wobben Properties GmbH, Aurich (DE)

(72) Inventors: Ingo MEYER, Wiesmoor (DE); Karsten ALBERS, Hinte (DE)

(21) Appl. No.: 16/628,589

(22) PCT Filed: Jul. 6, 2018
(86) PCT No.: PCT/EP2018/068359

§ 371 Date: Jan. 3, 2020

(30) Foreign Application Priority Data
Jul. 6, 2017 (DE) 10 2017 115 141.9

(51) Int. Cl. E04G 11/06; B28B 7/22

(52) U.S. Cl. CPC E04G 11/06; B28B 7/346; B28B 7/22

(57) ABSTRACT

A method for producing a concrete formwork for a component, in particular a tower segment for a tower, preferably a tower of a wind turbine, to a method for producing a component, in particular a tower segment for a tower, preferably a tower of a wind turbine, to a concrete formwork for a component, in particular a tower segment for a tower, preferably a tower of a wind turbine, to a component, in particular a tower segment for a tower, preferably a tower of a wind turbine, and to a pattern of a component, in particular a tower segment for a tower, preferably a tower of a wind turbine.

### BACKGROUND

### Technical Field

The invention relates to a method for producing a concrete formwork for a component, in particular a tower segment for a tower, preferably a tower of a wind turbine, a method for producing at least two different concrete formworks for at least two different components, in particular at least two different tower segments for a tower, preferably a tower of a wind turbine, a method for producing a component, in particular a tower segment for a tower, preferably a tower of a wind turbine, a concrete formwork for a component, in particular a tower segment for a tower, preferably a tower of a wind turbine, a component, in particular a tower segment for a tower, preferably a tower of a wind turbine, a pattern of a component, in particular a tower segment for a tower, preferably a tower of a wind turbine, the use of a pattern for producing a concrete formwork for a component, in particular a tower segment for a tower, preferably a tower of a wind turbine, and the use of a concrete formwork for producing a component, in particular a tower segment for a tower, preferably a tower of a wind turbine.

### Description of the Related Art

Components, such as in particular tower segments for a tower of a wind turbine, are often produced from concrete, in particular reinforced concrete and/or prestressed concrete.

For producing such components, generally a formwork is used, serving the purpose of giving liquid or flowable concrete (also referred to as fresh concrete) its form. The formwork is generally removed after the hardening or curing of the concrete (unless it is a permanent formwork). Since the formwork generally surrounds the component to be produced, the dimensions of a formwork are sometimes very great. The transport of formworks is therefore often very laborious, in particular if formworks for large special components are to be transported. Since the formwork gives the component to be produced from concrete its form, corresponding precision is required when setting up the formwork, which often consists of a number of individual parts. With imprecise formwork, the components produced with it may not be usable, or only to a limited extent, and or extensive finishing work may be required. For large special components, special formwork constructions are often also fabricated, for example as steel constructions. While these are often distinguished by high precision, they are however usually expensive and/or laborious to transport and/or not very flexible in the sense that they are only suitable for producing one specific component and cannot be used for components that differ in their geometry. Furthermore, the procurement time for special formwork constructions is often very great, and consequently represents a restrictive factor in the production of large quantities of components.

The German Patent and Trademark Office has searched the following prior art in the priority application relating to the present application: DE 23 29 243 A1, DE 42 42 584 A1 and DE 10 2010 003 931 A1.

### BRIEF SUMMARY

Provided is a method for producing a concrete formwork for a component, in particular a tower segment for a tower, preferably a tower of a wind turbine, a method for producing at least two different concrete formworks for at least two different components, in particular at least two different tower segments for a tower, preferably a tower of a wind turbine, a method for producing a component, in particular a tower segment for a tower, preferably a tower of a wind turbine, a concrete formwork for a component, in particular a tower segment for a tower, preferably a tower of a wind turbine, a component, in particular a tower segment for a tower, preferably a tower of a wind turbine, a pattern of a component, in particular a tower segment for a tower, preferably a tower of a wind turbine, a use of a pattern for producing a concrete formwork for a component, in particular a tower segment for a tower, preferably a tower of a wind turbine, and a use of a concrete formwork for producing a component, in particular a tower segment for a tower, preferably a tower of a wind turbine, that reduce or eliminate one or more of the disadvantages mentioned, in particular are improved and/or simplified and/or less expensive.

According to one aspect of the invention provided is a method for producing a concrete formwork for a component, in particular a tower segment for a tower, preferably a tower of a wind turbine, the method comprising providing a pattern of the component; erecting a production formwork around the pattern at a distance from the pattern, wherein a cavity produced between the production formwork and the pattern corresponds to the dimensions of the concrete formwork to be produced; filling the cavity with liquid concrete; hardening the concrete.

The method provides that a concrete formwork is produced for the component that is ultimately to be produced. The formwork for the component is consequently produced before the production process of this component, in that a concrete formwork is produced for the component. For this purpose, first a pattern of the component that is ultimately to be produced is required. A production formwork is erected around the pattern at a distance. Thus, a cavity is produced between the pattern and the production formwork. In particular, this cavity is delimited on at least one side by the pattern of the component and on at least one other side by the production formwork. The cavity is filled with liquid concrete, which is hardened. The concrete hardened in the cavity represents the concrete formwork with which components can be produced in the form of the pattern.

The invention is based inter alia on the realization that in this way a conventional formwork can be used as production formwork, in particular a formwork that is simple and/or inexpensive to set up and/or to transport. The production formwork does not have to meet any special requirements in terms of precision, since the production formwork is only relevant for the form of a rear side of the concrete formwork, which is facing away from the component to be produced with the concrete formwork. The side of the concrete formwork that is relevant for the form of the component to be produced with the concrete formwork is defined during the production of the concrete formwork by the pattern of the component.

It is therefore advantageous to use a pattern with great dimensional stability. For example, the pattern may be produced at a different location than the location at which the concrete formwork is produced. The pattern for a component can be simpler and/or easier and/or less expensive to transport than a formwork for producing the component. The method consequently makes it possible for example that patterns can be produced with high precision and transported to the location at which the components and/or the concrete formwork are to be produced. On account of the low requirements that the production formwork has to meet, production formwork for producing the concrete formwork can be put together and set up on site easily and inexpensively. For the dimensional stability of the component to be produced, the dimensional stability of the pattern is particularly relevant.

The production formwork consequently serves only for producing the concrete formwork, but not directly for producing the component. As also further described later, the component is produced by using the concrete formwork. Any number of components can be produced with the concrete formwork. Similarly, in turn, any number of concrete formworks can be produced with the pattern and the production formwork.

With the method described here, various advantages are obtained. The invention is used in particular for particularly large components with great dimensional accuracy, such as for example tower segments for a tower, in particular a tower of a wind turbine. Particularly large components are understood here as meaning in particular components with an end weight of over 10 tonnes, in particular over 25 tonnes, for example over 30 tonnes or over 50 tonnes. Particularly large components are also understood here as meaning in particular components in the form of rings or segments of a ring with a radius of at least 1 m, preferably at least 1.5 m, in particular at least 2 m and/or components in the form of segments of a ring with a radius of at least 2 m, preferably at least 3 m, in particular at least 4 m or at least 5 m.

For such particularly large components with great dimensional accuracy, such as for example tower segments for a tower, in particular a tower of a wind turbine, a correspondingly great dimensional accuracy of the formwork is required, which conventional formworks cannot provide. Formworks set up on site from individual formwork elements produce results that cannot be reproduced as well. Formworks of cured foam or the like do not offer sufficiently great dimensional accuracy for particularly large components, such as for example tower segments for a tower, in particular a tower of a wind turbine, in particular also not during the concreting process of the component to be produced. In the case of particularly large components, in particular large components in the form of rings or in the form of segments of a ring, high forces occur on the formwork during the concreting and hardening of the concrete, and in the case of formworks of cured foam or the like can for example lead to deformations. The invention is based inter alia on the realization that a concrete formwork and the method described herein are advantageous for this.

When reference is made in this description to the production formwork surrounding the pattern at a distance, this means in particular that the production formwork is at a distance on one or more sides of the pattern. In particular, it may be preferred that the production formwork does not surround the pattern completely, i.e., from all sides. For example, both the pattern and the production formwork may be arranged on a base. This base may for example be a formwork table and be regarded as part of the production formwork, but the base may also be something else, and for example not form part of the production formwork. The cavity formed between the pattern and the production formwork is consequently delimited at least on one side by the pattern and at least one other side by the production formwork. Further sides of the cavity may be delimited by other elements or else be open. In particular, it is preferred that an upwardly directed side of the cavity is at least partly open, while preferably liquid concrete can be introduced into the cavity through this open side of the cavity.

The production formwork may preferably rise up above the pattern in particular in the vertical direction. Furthermore, preferably the pattern may also rise up above the component to be produced with it in the vertical direction and or an extension element and/or a part of the production formwork may be arranged on the pattern. This serves in particular in the respect that, when producing the concrete formwork, the cavity does not have to be completely filled with liquid concrete in the upward direction, but instead an upward projection of the delimitation above the filling level of the concrete is realized.

Furthermore, it is preferred in particular to create a concrete formwork that rises up in the vertical direction above the component to be created with the concrete formwork. This has the advantage that, when producing a component by means of the concrete formwork, the cavity does not have to be completely filled with liquid concrete in the upward direction, but instead an upward projection of the concrete formwork above the filling level of the concrete is realized.

For a component for example in the form of a circular ring, a pattern correspondingly in the form of a circular ring is also used for producing a concrete formwork in the form of a circular ring. The concrete formwork may preferably have an inner portion in the form of a circular ring and an outer portion in the form of a circular ring, that is to say comprise two circular rings at a distance from one another. In the production of the concrete formwork, these two circular rings would be kept at a distance from one another by the pattern. In the production of a component by means of the concrete formwork, preferably the cavity between the two circular rings is filled with liquid concrete, which is intended to form the component later, after hardening.

For a component with the form of a segment of a circular ring, for example, preferably a corresponding pattern in the form of a segment of a circular ring is also used for producing a concrete formwork in the form of a segment of a circular ring. This concrete formwork preferably comprises an inner portion in the form of a segment of a circular ring and an outer portion in the form of a segment of a circular ring, between which the pattern is located during the production of the concrete formwork, and correspondingly, in the production of a component by means of the concrete formwork, the liquid concrete that is intended to form the component later, after the hardening, is introduced into the cavity between the two segments of a circular ring. Preferably, the end faces of the cavity between the pattern and the production formwork are delimited in the circumferential direction, so that in the production of the concrete formwork the liquid concrete cannot escape through the end faces in the circumferential direction. The delimitations of the end faces in the circumferential direction may be part of the production formwork. For example, the production formwork may be arranged such that it also extends at a distance from the end faces in the circumferential direction of the pattern, so that the concrete formwork also has corresponding end faces in the circumferential direction, which may in particular connect the inner portion and the outer portion of the concrete formwork.

Furthermore, in the later production of the component, the end faces are preferably delimited in the circumferential direction of the cavity between the inner portion and the outer portion of the concrete formwork, so that also in the production of the component the liquid concrete cannot escape through the end faces in the circumferential direction. As previously described, this can preferably be realized by the concrete formwork having end faces in the circumferential direction.

When reference is made in this description to a pattern and/or a component and/or a concrete formwork, this means in particular a first pattern and/or a first component and/or a first concrete formwork. Understood here as the component is in particular a tower segment for a tower, preferably a tower of a wind turbine. A tower segment may be a portion in the form of a ring of a tower, in particular a tower of a wind turbine. A tower segment may however also merely have the form of a segment of a circular ring, so that a portion in the form of a ring of a tower may be made up of a number of tower segments. A component or tower segment may also take the form of a panel or cuboid. The methods, features and aspects described here can similarly be applied to components or tower segments in the form of panels or cuboids. Terms such as circumferential direction or radius should then be correspondingly applied to a form of the component or tower segment in the form of a panel or cuboid, for example with regard to the thickness or longitudinal extent of the component or tower segment.

When reference is made in this description to liquid concrete, this means in particular liquid or flowable fresh concrete, in particular liquid or flowable fresh concrete of the quality that is required and/or desired for producing the concrete formwork and/or the component. In particular, the requirements for the properties of the concrete for producing the concrete formwork on the one hand and the component on the other hand may differ, so that concrete of different qualities and/or with different properties are used for the concrete formwork and the component.

Preferably, the method for producing a concrete formwork for a component is also characterized by removing the production formwork. The production formwork may preferably be removed from the concrete formwork after the hardening of the concrete of the concrete formwork. This may take place for example by transporting and/or detaching the production formwork and/or transporting the hardened concrete formwork.

Preferably, the method for producing a concrete formwork for a component is also characterized by removing the pattern. Preferably, the pattern is removed after the hardening of the concrete of the concrete formwork. This may take place for example by transporting the pattern and/or transporting the hardened concrete formwork. Preferably, as also described further below, the concrete formwork may be separated into two or more parts. Preferably, the concrete formwork and/or parts thereof may be moved, for example by means of hydraulics or by lifting with a crane, in particular in order to strip the pattern (or a component produced later with the formwork).

Furthermore, the method for producing a concrete formwork for a component is preferably developed further by: coating the surfaces facing the pattern in the production of the concrete formwork with an anti-adhesion coating.

Preferably, one of, some of or all of the surfaces of the concrete formwork that are facing the pattern in the production of the concrete formwork are coated with an anti-adhesion coating. This serves in particular in the respect that, in later production of a component with the concrete formwork, adhesive attachment of the concrete of the component to the concrete of the concrete formwork can be prevented or reduced.

The coating with an anti-adhesion coating may for example take place after the hardening of the concrete, possibly after the removal of the pattern. For example, the coating with an anti-adhesion coating may take place by applying a coating material, such as for example a concrete release agent, a lacquer, in particular a PU-based dye, a film, or the like. Examples of concrete release agents are for instance water-soluble formwork oils, water-insoluble formwork oils, formwork pastes, formwork waxes and chemically reactive release agents. Concrete release agents are generally used in order to reduce the adhesion between the concrete and the formwork. In conventional formworks that do not have concrete surfaces, applying the release agent generally has the effect of reducing the water absorbency of the formwork skin, and consequently achieves a closing of the pores or a reduction of the pores.

The coating with an anti-adhesion coating may also be realized by a coating material, for example in the form of a film, a mat or the like, being introduced before or while liquid concrete is filled or is being filled into the cavity between the production formwork and the pattern, on the side of the cavity that is facing the pattern.

Furthermore, the method for producing a concrete formwork for a component is preferably developed further by: coating the surfaces facing the pattern in the production of the concrete formwork with a primer coating and subsequently with an anti-adhesion coating. Preferably, a first coating material, for example a lacquer, may be applied as a primer coating to some of or all of the surfaces of the concrete formwork that are facing the pattern in the production of the concrete formwork. Subsequently, preferably a second coating material, in particular different from the first, for example a concrete release agent or anti-adhesion coating, is applied to some of or all of the surfaces of the concrete formwork that are facing the pattern in the production of the concrete formwork. This is preferred in particular in order to prepare the surfaces in such a way that for example concrete release agents adhere to the primer coating, since concrete release agents generally do not adhere well to concrete surfaces.

In a preferred embodiment of the method for producing a concrete formwork for a component, it is provided that the dimensions of the pattern are increased in comparision with the component to be produced with the concrete formwork by a shrinkage allowance for the concrete. During the hardening, the liquid concrete changes its volume, in particular by giving off moisture (drying out) and by chemical reactions or structural changes. This reduction in volume is also referred to as shrinkage, the degree or size of the reduction in volume being referred to as the shrinkage allowance. In order that a component of the desired dimensions can be produced by means of the concrete formwork, it is preferred that the pattern for producing the concrete formwork is larger in comparison with the component to be produced with the concrete formwork, for example by the shrinkage allowance for the concrete, preferably the concrete that is used for producing the component. Preferably, it may additionally be taken into account in the dimensioning of the pattern that the concrete of the concrete formwork also shrinks during hardening. Therefore, it may for example be provided that, although the pattern is larger than the component to be produced with it, it is reduced by a fraction that is compensated by the shrinkage of the concrete formwork. It is thus preferred that the dimensions of the pattern are increased in comparison with the component to be produced with the concrete formwork by an amount that takes into account shrinkage allowances for the concrete both of the concrete formwork and of the component to be produced with the concrete formwork. The shrinkage allowances for the concrete are in particular also dependent on the geometry of the component. For example, when taking into account the shrinkage allowances for the concrete, account should also be taken of the wall thickness, the quality of the concrete used, the surroundings (for example air humidity, temperature, etc.) during the drying of the concrete, and the like. In the case of high-strength concretes, a shrinkage allowance of about 0.3 mm/m of wall thickness may for example be taken.

Furthermore, it is preferred that the method for producing a concrete formwork for a component is characterized in that it comprises arranging rails on the concrete formwork. Rails may be used for example for arranging a grinding machine, in order preferably to machine an upper flange. In particular, it is preferred that the rails are anchored on the concrete formwork.

A preferred development of the method for producing a concrete formwork for a component provides that inserts are arranged at one, two or more locations. In particular, it is preferred that inserts are arranged in regions of edges, corners, clearances and similar geometries. The inserts are preferably formed from a metal material, in particular steel, or comprise such a material. The inserts may for example be formed as a two-dimensional element, in particular as a metal sheet. Such inserts may for example prevent or at least reduce the partial or complete breaking off of certain locations.

Preferably, the method for producing a concrete formwork for a component is also characterized by reinforcing the cavity with a reinforcement and/or introducing auxiliary means for the use and/or transport of the concrete formwork to be produced. Preferably, before the filling of the cavity with liquid concrete, a reinforcement and/or auxiliary means for the use and/or transport of the concrete formwork may be introduced into the cavity. The reinforcement and/or the auxiliary means may for example also be produced and/or provided (entirely or partially) in advance and the production formwork and the pattern arranged alongside the reinforcement and/or the auxiliary means, to create the corresponding cavity. The reinforcement may for example also be provided as a prefabricated reinforcement cage. The auxiliary means for the use and/or transport of the concrete formwork may for example comprise lifting anchors, sleeve dowels or the like. The auxiliary means may for example be fastened on the reinforcement.

A preferred development of the method for producing a concrete formwork for a component is distinguished by the fact that the reinforcement consists of steel or comprises steel; and/or the reinforcement consists of textile structures or comprises textile structures; and/or the reinforcement consists of glass-fiber reinforced plastic or comprises glass-fiber reinforced plastic; and/or the reinforcement consists of fiber fabric, in particular glass-fiber and/or synthetic-fiber fabric, or comprises fiber fabric, in particular glass-fiber and/or synthetic-fiber fabric. The textile structures and/or the fiber fabric may for example comprise or consist of carbon fibers and/or alkali-resistant fibers.

According to a preferred embodiment of the method for producing a concrete formwork for a component, it is provided that the concrete formwork comprises two portions, in particular an inner portion and an outer portion, which may be produced at the same time or one after the other. As already explained above, the inner portion and the outer portion may take the form of circular rings or have the form of a segment of a circular ring. Furthermore, the concrete formwork may also have more than two portions. For example, an inner portion and an outer portion in the form of segments of a circular ring may be connected by connecting portions at the circumferential surface of the end sides.

It is also preferred that the method for producing a concrete formwork for a component is characterized by separating the concrete formwork into two or more partial concrete formworks. It may be preferred to separate the concrete formwork into two or more partial concrete formworks, in particular after the hardening of the concrete, for example in order to be able to transport or store the concrete formwork more easily and/or be able to strip the pattern or a component produced with the concrete formwork more easily. A separation of the concrete formwork may take place in particular in the horizontal direction and/or vertical direction and/or radial direction and/or circumferential direction. Preferably, the concrete formwork has two separating locations, which may be located in particular on opposite regions of the concrete formwork. With respect to the concrete formwork of a circular form, with two separating locations, they are preferably located in a region at 0 degrees and at 180 degrees. Such concrete formworks may be used for example for full segments and/or for half-segments. Furthermore, it may be preferred to provide three or more separating locations on the concrete formwork. With respect to a concrete formwork of a circular form, with three separating locations, they are preferably located in a region at 0 degrees, at 120 degrees and at 240 degrees.

A further preferred development of the method for producing a concrete formwork for a component is distinguished by the fact that the production formwork is formed as concrete formwork and/or fixed formwork and/or timber formwork and/or girder formwork and/or panel formwork and/or permanent formwork and/or single-face formwork and/or double-face formwork and/or freeform formwork and/or round formwork; and/or the production formwork has dimensions that are suitable for road transport. As also already mentioned above, the production formwork merely serves for forming a side of the concrete formwork that is facing away from the component to be produced with the concrete formwork. This side of the concrete formwork that is facing away from the component to be produced is not relevant for the dimensional stability of the component. Therefore, any desired formwork may be used as production formwork, as long as it makes production of the concrete formwork possible. In particular, the type of production formwork may be adapted to the circumstances on site with regard to availability and/or costs.

It is also provided that the pattern consists of steel and/or comprises steel; and/or the pattern consists of a steel alloy and/or comprises a steel alloy; and/or the pattern has dimensions that are suitable for road transport, and/or the pattern can be made up from two or more partial patterns, and the two or more partial patterns have in each case dimensions that are suitable for road transport. Furthermore, it may be preferred that the pattern consists of aluminum, and/or of a composite material, in particular glass-fiber and/or carbon-fiber reinforced plastic, or comprises aluminum, and/or a composite material, in particular a glass-fiber and/or carbon-fiber reinforced plastic. These refinements are preferred in order to ensure a great dimensional stability of the pattern, in particular also in the case of multiple use for the production of concrete formworks, and/or in order to facilitate transport of the pattern, in particular even over relatively great distances. The dimensional stability of the pattern preferably has to meet high requirements, it may be preferred to produce patterns centrally and/or at a location particularly qualified to do so and transport them to the location at which components corresponding to the pattern are to be produced, for which purpose first a concrete formwork is created. A form of the pattern with great dimensional stability and/or favorable transporting dimensions is consequently advantageous. Preferably, the pattern is formed as a hollow element, possibly with internal supporting struts and/or a filling of some other material, in particular lightweight and/or rigid material. This allows the weight of the pattern to be reduced.

According to a further aspect of the invention, provided is a method for producing at least two different concrete formworks for at least two different components, in particular at least two different tower segments for a tower, preferably a tower of a wind turbine, the method comprising producing a first concrete formwork by the previously described method; providing a second pattern of a second component, which is different from the first; erecting the production formwork, previously used for the production of the first concrete formwork, around the second pattern at a distance from the second pattern, wherein a cavity produced between the production formwork and the second pattern corresponds to the dimensions of the second concrete formwork to be produced; filling the cavity with liquid concrete; hardening the concrete.

According to this aspect of the invention, the same production formwork is used for producing concrete formworks for different components, in particular components that are different with regard to their geometry, such as for example tower segments with a different radius and/or different taper for installing at different tower heights. However, the patterns used for the first concrete formwork and for the second concrete formwork differ, and the components to be produced with the first concrete formwork and with the second concrete formwork differ. The production formwork can be used unchanged or identically for producing both concrete formworks, in particular if the differences with regard to the geometry of the two patterns are minor. However, modifications to the production formwork may also be performed, for example one more or one fewer formwork element may be used in the case of a round formwork, depending on which radius of the polygon of the round formwork is to be achieved. Otherwise, the method for producing concrete formworks for different components may be developed according to the developments of the previously described method for producing a concrete formwork.

According to a further aspect of the invention, provided is a method for producing a component, in particular a tower segment for a tower, preferably a tower of a wind turbine, the method comprising providing a concrete formwork produced by the previously described method; filling a cavity formed by the concrete formwork with liquid concrete; hardening the concrete.

The provision of a concrete formwork produced by the previously described methods possibly comprises producing and/or transporting the concrete formwork. The features and details described with reference to the method for producing the concrete formwork that are also relevant and/or advantageous for the production of a component apply similarly with reference to the method for producing a component.

According to a preferred embodiment, it is provided that the method for producing a component is characterized by removing the concrete formwork; and/or reinforcing the cavity with a reinforcement; and/or introducing guides for tensioning wires and/or lines and/or cables into the cavity; and/or finishing, in particular grinding and/or coating, the component.

The guides may for example be formed as empty tubes. The reinforcement of the cavity and/or the introduction of guides preferably takes place before the filling of the cavity with liquid concrete. Finishing of the component preferably takes place after the stripping of the component, in particular after the removal of the concrete formwork.

According to a further aspect of the invention, provided is a concrete formwork for a component, in particular a tower segment for a tower, preferably a tower of a wind turbine, characterized in that the concrete formwork was produced in a previously described method.

The concrete formwork is distinguished in particular by the fact that it has a structured surface on an outer circumferential surface, which in the production process is facing the production formwork. The structured surface may in particular have a structure of a coarse-pored concrete. For example, the structured surface could comprise the negative of voids. In particular, the surface may have a finish that is different from a metal surface. Furthermore, the surface may have impressions, in particular vertically extending impressions, which are caused by the butt joint of two elements of the production formwork. In addition, the outer circumferential geometry of the concrete formwork may have an unround, and/or oval, and/or angular form.

According to a further aspect of the invention, provided is a component, in particular a tower segment for a tower, preferably a tower of a wind turbine, characterized in that the component was produced in a previously described method and/or by using a previously described concrete formwork.

The component produced in a previously described method and/or by using a previously described concrete formwork may for example be distinguished by two or more negative locations of butt joints, wherein two elements of the concrete formwork are or were arranged against one another at the butt joints.

According to a further aspect of the invention, provided is a component, in particular a tower segment for a tower, preferably a tower of a wind turbine, characterized in that the dimensions of the pattern are increased in comparision with the component to be produced with the concrete formwork by a shrinkage allowance for the concrete.

According to a preferred embodiment of the pattern, it is provided that the pattern consists of steel and/or comprises steel; and/or the pattern consists of a steel alloy and/or comprises a steel alloy; and/or the pattern has dimensions that are suitable for road transport; and/or the pattern can be made up from two or more partial patterns, and the two or more partial patterns have in each case dimensions that are suitable for road transport.

According to a further aspect of the invention, provided is a use of a previously described pattern for producing a concrete formwork for a component, in particular a tower segment for a tower, preferably a tower of a wind turbine.

According to a further aspect of the invention, provided is a use of a concrete formwork, in particular a previously described concrete formwork for producing a component, in particular a tower segment for a tower, preferably a tower of a wind turbine.

For the advantages, configurational variants and configurational details of the respective further aspects of the inventions and their possible developments, reference is also made in particular to the foregoing description in relation to the corresponding features of the other aspects of the invention.

Further advantageous configurational variants of the methods and devices according to the invention are obtained by combining the preferred features discussed here.

### BRIEF DESCRIPTION OF THE SEVERAL VIEWS OF THE DRAWINGS

Preferred embodiments of the invention are described by way of example on the basis of the accompanying figures, in which:

FIG. 1 shows a schematic representation of a wind turbine with a tower with components produced according to an embodiment of the invention;

FIG. 2 shows a schematic representation of an embodiment, given by way of example, of the method according to an embodiment of the invention for producing a concrete formwork for a component, in particular a tower segment for a tower of a wind turbine;

FIG. 3 shows a schematic cross section through an embodiment, given by way of example, of a production formwork and a pattern for a component;

FIG. 4 shows the cross section as shown in FIG. 3 with concrete formwork;

FIG. 5 shows a formwork according to the prior art, which can be used as production formwork;

FIG. 6 shows a schematic cross section through an embodiment, given by way of example, of a concrete formwork;

FIG. 7 shows the cross section as shown in FIG. 3 with a component.

### DETAILED DESCRIPTION

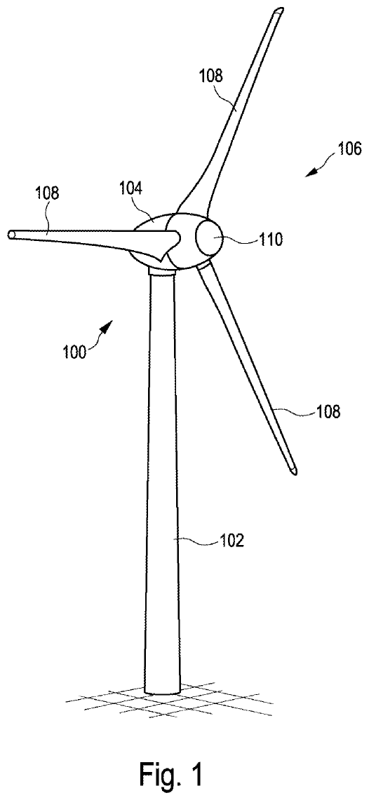

FIG. 1 shows a wind turbine 100 with a tower 102 and a nacelle 104. Arranged on the nacelle 104 is a rotor 106 with three rotor blades 108 and a spinner 110. During operation, the rotor 106 is set in a rotary motion by the wind, and thereby drives a generator in the nacelle 104. The tower 102 has components that were produced by the method described here.

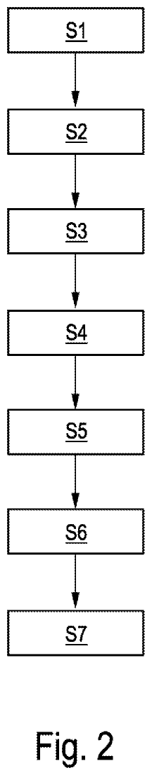

The schematic representation of an embodiment, given by way of example, of the method according to the invention for producing a concrete formwork for a component, in particular a tower segment for a tower of a wind turbine according to FIG. 2, comprises the following steps: S1: providing a pattern of the component; S2: erecting a production formwork around the pattern at a distance from the pattern, wherein a cavity produced between the production formwork and the pattern corresponds to the dimensions of the concrete formwork to be produced; S3: filling the cavity with liquid concrete; S4: hardening the concrete; S5: removing the production formwork; S6: removing the pattern; S7: coating the surfaces facing the pattern in the production of the concrete formwork with an anti-adhesion coating.

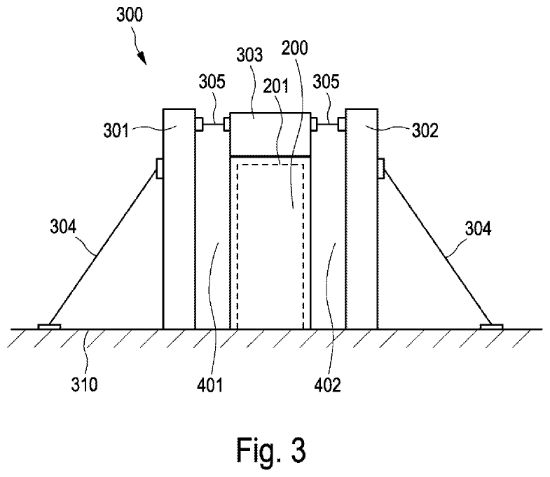

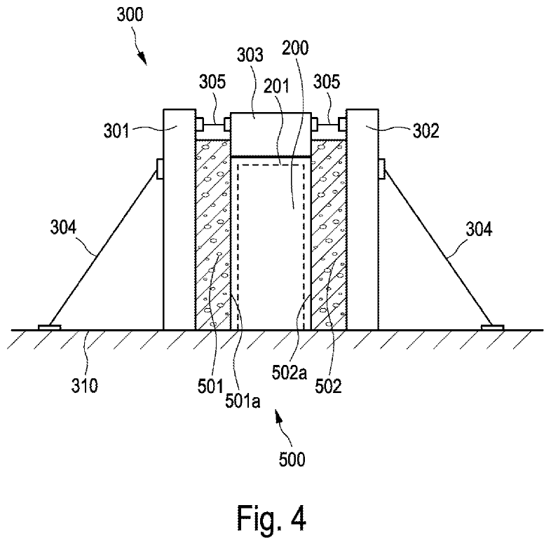

FIG. 3 shows a schematic cross section through an embodiment, given by way of example, of a production formwork 300 and a pattern 200 for a component; FIG. 4 shows the cross section as shown in FIG. 3 with the concrete formwork 501, 502. According to FIG. 3, a pattern 200 of a component can be seen, arranged on a base or formwork table 310. It is indicated by the broken line 201 that the pattern 200 is increased in size by a shrinkage allowance for the concrete that is used for the component to be produced. The broken line 201 schematically represents the geometry of the component to be produced, smaller by the shrinkage allowance for the concrete. In FIG. 3, parts 301, 302 of the production formwork 300 are arranged alongside the pattern 200, at a distance from it, to the right and left. Formed between the part 301 of the production formwork 300 and the component 200 is a cavity 401, between the part 302 of the production formwork 300 and the component 201 a further cavity 402. Arranged on the component 200 is a further part 303 of the production formwork 300. The parts 301, 302 of the production formwork are supported by bracings 304. Alternatively or in addition, the parts 301, 302 may also be connected, in particular bolted, to the formwork table 310. The part 303 of the production formwork 300 is supported with respect to the parts 301, 302 of the production formwork 300 by way of struts 305. The cavities 401, 402 are delimited in the downward direction by the floor or formwork table 310 and are open in the upward direction, so that the liquid concrete can be introduced into the cavities 401, 402 from above. To the sides, the cavities 401, 402 are delimited by the pattern 200 and the parts 301, 302 of the production formwork 300. The cavities 401, 402 are preferably also delimited at the end faces, which cannot be seen in FIG. 3. The delimitation may be realized by a further formwork part (not represented).

As can be seen in FIG. 4, the cavities 401, 402 according to FIG. 3 have been filled with liquid concrete and the concrete has been hardened, so that the two portions 501, 502 of the concrete formwork 500 have been created. The two portions 501, 502 of the concrete formwork 500 may also be referred to as the inner portion and outer portion, in particular if the component to be produced is a component in the form of a circular ring or a component with the form of a segment of a circular ring.

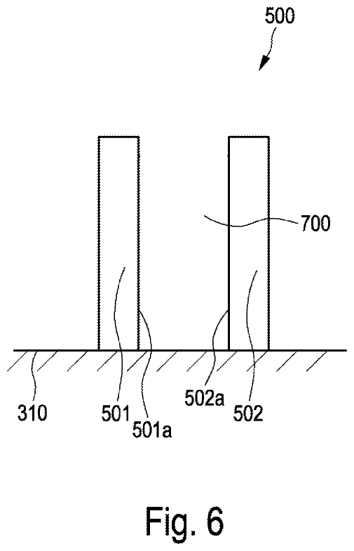

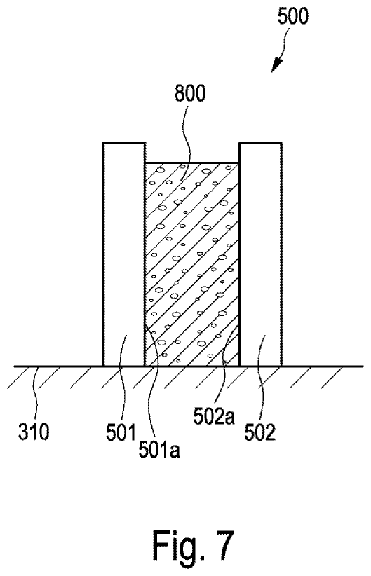

In the production of the concrete formwork 500, the surfaces 501a, 502a are facing the pattern 200 and, in the production of the component 800, facing the component 800 or previously the cavity 700 (see FIGS. 6 and 7). These surfaces 501a, 502a are preferably coated with an anti-adhesion coating, in order to avoid or reduce adhesive attachment of the component 800 to the concrete formwork 500. Oils or epoxides may be used for example as the anti-adhesion coating.

FIG. 6 shows a schematic cross section through an embodiment, given by way of example, of a concrete formwork 501, 502; FIG. 7 shows the cross section as shown in FIG. 3 with the component 800. After the removal of the pattern 200 and the production formwork 300, the concrete formwork 500 produced can be used on a base or formwork table 310 for producing a component. For this purpose, the cavity 700 between the portions 501, 502 of the concrete formwork 500 is filled with liquid concrete, which after hardening forms the component 800.

The dimensional stability of the component 800 to be produced with the concrete formwork 500 is influenced by the surfaces 501a, 502a facing the pattern 200 in the production of the concrete formwork 500, not by the surfaces facing the production formwork 300 in the production of the concrete formwork 500. Therefore, a simple formwork that meets lower requirements for precision can be used for the production formwork 300. By contrast, the pattern 200, which is produced with the greatest possible dimensional stability, can preferably be reused for producing any number of concrete formworks 500, and on account of the transport dimensions can preferably be transported even over relatively long distances.

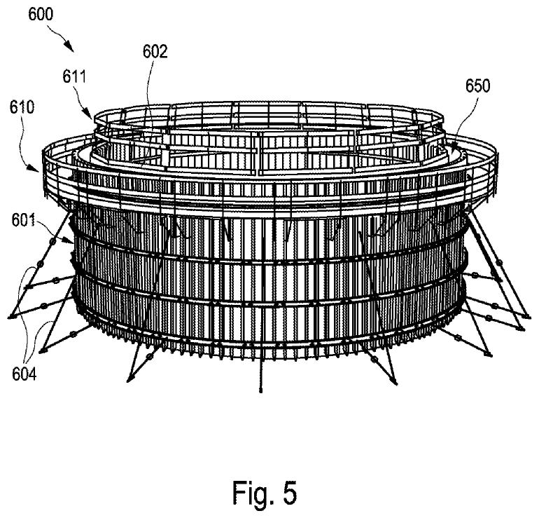

Shown in FIG. 5 is a round formwork 600 according to the prior art, which can be used as production formwork. The round formwork 600 according to FIG. 5 has an outer formwork part 601 and an inner formwork part 602, formed between which is a cavity 650, which can be filled with liquid concrete in order to produce a component in the form of a ring. The supporting struts 604, by which the outer formwork part 601 is supported, can be seen. At the upper end, the inner formwork part 602 has a railing 611. Formed at the upper end of the outer formwork part 601 is a peripheral walkway 610, likewise with a railing. Such round formworks 600 are known in the prior art and can be used flexibly, including for different radii. However, for changing geometries of tower segments, in particular tapering tower segments and/or other particular geometries in the tower segments, considerable adaptations are required and cannot be realized with existing formwork, or only with great effort and special quality control with regard to precision. It is therefore also possible to use such flexibly usable formworks as the round formwork 600 as production formwork, in order to enclose the sides of the concrete formwork that are facing away from the pattern—and consequently the component to be produced later. In this way, for example, even special geometries, such as for example tapering components, can be produced with concrete formworks for which the same or only a slightly modified production formwork was used.

1. A method comprising:
producing a concrete formwork for a component for a tower of a wind turbine, the producing comprising:
providing a pattern of the component;
erecting a production formwork around the pattern at a distance from the pattern, wherein a cavity is produced between the production formwork and the pattern and corresponds to dimensions of the concrete formwork to be produced;
filling the cavity with liquid concrete; and
hardening the concrete to the form the concrete formwork.

2. The method as claimed in claim 1, comprising:
removing the production formwork; and
removing the pattern.

3. The method as claimed in claim 1, comprising:
coating surfaces of the concrete formwork facing the pattern with an anti-adhesion coating; or
coating surfaces of the concrete formwork facing the pattern with a primer coating and an anti-adhesion coating.

4. The method as claimed in claim 1, wherein:
the dimensions of the pattern are increased in comparison with the component to be produced with the concrete formwork by a shrinkage allowance for the hardening of the concrete; or
dimensions of the pattern are increased in comparison with the component to be produced with the concrete formwork by an amount that takes into account shrinkage allowances for the hardening of the concrete both of the concrete formwork and of the component to be produced with the concrete formwork.

5. The method as claimed in claim 1, comprising:
reinforcing the cavity with a reinforcement; and/or
introducing auxiliary means for the use or transport of the concrete formwork to be produced.

6. The method as claimed in claim 1, wherein the concrete formwork comprises an inner portion and an outer portion that are produced simultaneously.

7. The method as claimed in claim 1, comprising:
separating the concrete formwork into two or more partial concrete formworks.

8. The method as claimed in claim 1, wherein:
the production formwork is at least one of: a concrete formwork, a fixed formwork, a timber formwork, a girder formwork, a panel formwork, a permanent formwork, a single-face formwork, a double-face formwork, a freeform formwork, or a round formwork; and
the production formwork has dimensions that are suitable for road transport.

9. A method comprising:
producing first and second concrete formworks for at least two different components for a tower of a wind turbine the producing comprising:
producing a first concrete formwork by the method as claimed in claim 1, wherein the pattern is a first pattern;
providing a second pattern of a second component, wherein the second pattern is different from the first pattern;
erecting the production formwork, previously used for the production of the first concrete formwork, around the second pattern at a distance from the second pattern, wherein a cavity is produced between the production formwork and the second pattern and corresponds to dimensions of the second concrete formwork to be produced;
filling the cavity with liquid concrete; and
hardening the concrete to produce the second concrete formwork.

10. A method comprising:
producing a component for a tower of a wind turbine, the producing comprising:
providing a concrete formwork produced by the method as claimed claim 1;
filling a cavity formed by the concrete formwork with liquid concrete; and
hardening the concrete to produce the component.

11. The method for producing a component as claimed in claim 10, comprising:
removing the concrete formwork;
reinforcing the cavity with a reinforcement;
introducing guides for tensioning wires, lines, or cables into the cavity; and
finishing by at least one of: grinding or coating the component.

12. A concrete formwork for a component for a tower of a wind turbine, wherein the concrete formwork was produced in the method as claimed in claim 1.

13. A component for a tower of a wind turbine wherein the component was produced by the method as claimed in claim 10.

14. A pattern of a component for a tower of a wind turbine, dimensions of the pattern are increased in comparison with the component to be produced with the concrete formwork by a shrinkage allowance for the concrete; and
dimensions of the pattern are increased in comparison with the component to be produced with the concrete formwork by an amount that takes into account shrinkage allowances for the concrete both of the concrete formwork and of the component to be produced with the concrete formwork.

15. (canceled)

16. The concrete formwork as claimed in claim 12, wherein the component is a tower segment for the tower of the wind turbine.

17. The method as claimed in claim 10, wherein the component is a tower segment of a wind turbine.

18. The method as claimed in claim 1, wherein the component is a tower segment of a wind turbine.

19. The method as claimed in claim 1, wherein the concrete formwork comprises an inner portion and an outer portion that are produced one after the other.
